(19) United States
(12) Patent Application Publication
(10) Pub. No.: US 2005/0289128 A1
(43) Pub. Date: Dec. 29, 2005

(54) Document matching degree operating system, document matching degree operating method and document matching degree operating program

(75) Inventor: Yoshitaka Hamaguchi, Nara (JP)

Correspondence Address: VENABLE LLP, P.O. BOX 34385, WASHINGTON, DC, 20045-9998, US

(73) Assignee: Oki Electric Industry Co., Ltd., Tokyo (JP)

(21) Appl. No.: 11/150,227

(22) Filed: Jun. 13, 2005

(30) Foreign Application Priority Data
Jun. 25, 2004 (JP) 2004-188434

(51) Int. Cl. G06F 7/00

(52) U.S. Cl. 707/3

(57) ABSTRACT

In the present invention, a document matching degree indicating a matching degree of a target document with one or more search terms is calculated based on information in a plural documents information storing part, by calculating a TF term reflecting a frequency of the input search term in the target document and an IDF term reflecting an importance of the input search term in the target document, and from the TF term and the IDF term for each search term. Then there is calculated an expectation value of a number of appearances of a search term t in a target document d, by approximating the document set σ(t) by an appearing document set κ(t), and there is reflected, in the TF term, a disagreement of the expectation value with an actual number of appearances of the search term t in the target document d.

### CROSS REFERENCE TO RELATED APPLICATIONS

The disclosure of Japanese Patent Application No. JP2004-188434, filed on Jun. 25, 2004, entitled “DOCUMENT MATCHING DEGREE OPERATING SYSTEM, DOCUMENT MATCHING DEGREE OPERATING METHOD AND DOCUMENT MATCHING DEGREE OPERATING PROGRAM”. The contents of that application are incorporated herein by reference in their entirety.

### BACKGROUND OF THE INVENTION

The present invention relates to document matching degree operating system, document matching degree operating method and document matching degree operating program, which are applicable to the case of searching a document based on a sentence which has been input or one or more keywords (search terms), for example.

### DESCRIPTION OF THE RELATED ART

When searching a document appropriate for one or more search terms (including a case of using a word in an input sentence as a search term), the score (evaluated value) of document is calculated in some way and a search result is shown in the order of score from highest to lowest. This method is widely used.

Generally, the score mentioned above includes a TF term which is determined by TF(d, t) as the number of appearances of a search term t in a document d to be a search target and which results from a relation between the document d and the search term t. The score, which also includes a term for calculating an importance unique for the search term t and in which idf is used in many cases, will be called an IDF term. The score of the document d is generally represented by the sum of the product of the TF term and the IDF term for all search terms.

There is described a score often used in a conventional document such as “Information Retrieval Using Location and Category Information (ichi jouhou to bunnya jouhou wo mochiita jouhou kensaku)” (co-authored Masaki Murata et al., Journal of Information Processing Society of Japan (natural language processing) Vol. 7, No. 2) by the following formula (1), (2), (3), (4).

$$\begin{matrix}Score ( d ) = {\sum }_{1} ( \frac{TF ( d , t )}{\frac{length ( d )}{Δ} + TF ( d , t )} \cdot log ( \frac{N}{DF ( t )} ) ) & Formula ( 1 ) \\ TF term = \frac{TF ( d , t )}{\frac{length ( d )}{Δ} + TF ( d , t )} & Formula ( 2 ) \\ IDF term = log ( \frac{N}{DF ( t )} ) & Formula ( 3 ) \\ TF term ( transformation type 1 ) = \frac{\frac{TF ( d , t )}{length ( d )}}{\frac{1}{Δ} + \frac{TF ( d , t )}{length ( d )}} & Formula ( 4 )\end{matrix}$$

In this formula, length (d) is the length of the document d, Δ is an average document length in all documents, DF(t) is the number of documents in which the term t appears and N is all document number.

The TF term shown in formula (2) in the score shown in formula (1) functions so that the larger TF(d, t) becomes in the document d (in other words, the search term appears many times per unit document length) the higher score may become. It is possible to confirm that the TF term reflects the number of appearances of term per unit document length from formula (4) modified from the formula (2). Since a term is likely to appear repeatedly generally as a document becomes longer, a score becomes higher and only a long document is shown as a search result. To prevent this, normalization as above is performed. In other words, an index is decided that a search term is included in a document length at a constant rate.

On the other hand, the IDF term shown in formula (3) indicates that the smaller DF(t) becomes, in other words, the smaller the number of documents including a term is, the more important the term becomes. This is because searching by a term appearing only in smaller number of documents is more effective to narrow down a document and such a term is characteristic in many cases. For example, “fuel cell” appears only in a document related thereto while “research” and “perform” appear in a wide variety of documents. In this case, “fuel cell” is appropriate for a search term. The IDF term expresses the importance of such a term.

### SUMMARY OF THE INVENTION

However, the score (evaluated value) of document shown in the formula (1) has the following problems A-C.

(Problem A)

The TF term in the conventional technology can be modified as formula (5). Here, the score resulting from the search term t in the document d can also be determined by (TF(d, t)·Δ/length (d)). This variable (TF(d, t)·Δ/length (d)) indicates that the smaller the number of search terms t per unit document length is the lower the score becomes.

$$TF term ( transformation type 2 ) = \frac{\frac{TF ( d , t ) \cdot Δ}{length ( d )}}{1 + \frac{TF ( d , t ) \cdot Δ}{length ( d )}} \qquad Formula ( 5 )$$

However, even when TF(d, t) per unit document length is small, it is impossible to know the cause of low score by which reason either the following (a) or (b): (a) only a small number of search terms t is included in the document d, which is not a target document; or (b) the number of appearances of the search term t, which is a specific term such as a technical term hard to be used repeatedly in a document, is small in any document and, as a result, the number of appearances is small in the document d as well. In the case of (b), the score should not be low in a normal situation.

When searching documents such as article and patent document which are uniform in quality and in which an important term is likely to be repeated, the score is not lowered by the above (b), which does not create a problem. However, as represented by Web page, when searching documents which are not uniform in quality and in which a simple expression or spoken language is likely to be used, the case of (b) increases for an important term as search term such as technical term. For this reason, adopting the conventional score calculating method to search for such documents, the score of repeatable and general term becomes higher and it becomes difficult to obtain enough accuracy.

(Problem B)

When a document to be a search target is, for example, article and patent document, an important term is likely to be repeated. However, there are many short sentences and a characteristic term is unlikely to be repeated in Web page and so on.

In the conventional method, the TF term is decided by (TF(d, t)·Δ/length (d)). Therefore, TF(d, t) is likely to be large in such a document as article in which a term is likely to be repeated, and (TF(d, t)·Δ/length (d)) also becomes large while (TF(d, t)·Δ/length (d)) is likely to be small in such a document as Web page in which a term is unlikely to be repeated.

In other words, changing a document set to be a search target finally changes the score of the document calculated by the formula (1). This means that a search target changes criterion of judgment to what degree of score of document indicates good result. In other words, in the case of switching various types of document groups to be the search target, it is impossible to perform uniform process such as: “since the document by this score is appropriate, the document is forwarded to the next process or displayed.” Or, it is necessary to seek and decide in advance the threshold value per document group.

(Problem C)

According to the IDF term in the conventional technology, when the number DF(t) of documents including the search term t is almost equal, the search terms t included in the documents are equally important irrespective of repeatability of the search term t in the documents. However in the TF term, since the score is decided according to magnitude of TF(d, t) as the number of the search terms t, too small number thereof as a whole does not mean anything statistically. In a document in which the search term appears, for example, when the search term appears only once or so, there are only two cases of the TF term score in which TF(d, t) is 0 or 1. The search term is considered having lower validity of score than a search term which can take more values of TF(d, t).

When searching documents such as article and patent document which are uniform in quality and in which an important term is likely to be repeated, there is not a big problem in most cases, in which the number of appearances TF(d, t) of important term is large. However, as represented by Web page, when searching documents which are not uniform in quality and in which a simple expression or spoken language is likely to be used, even an important term is repeated infrequently in many cases and the gap widens between the search term appearing repeatedly and the term which does not appear repeatedly in the same document even with almost the same DF(t). In the conventional technology, in this case, the score of the term having little meaning statistically although with almost the same DF(t) is to be of equal rank, and thereby the validity of whole score is lowered.

In view of the aforementioned problems, there is desired a document matching degree operating system, a document matching degree operating method and a document matching degree operating program which are capable of properly evaluating matching degree of document with search term irrespective of document type.

According to one aspect of the present invention, to solve the aforementioned problems, there is provided a document matching degree operating system for obtaining a document matching degree as an index value indicating a matching degree of a target document with one or more search terms from information on document set to which the one or more search terms are input and includes a plurality of documents including the target document to be a search target, the document matching degree operating system comprising: (1) a plural documents information storing part for storing the information on document set; (2) a TF term operating part for calculating a TF term reflecting a frequency of the input search term in the target document by retrieving a specific information from the plural documents information storing part; (3) an IDF term operating part for calculating an IDF term reflecting an importance of the input search term in the target document by retrieving a specific information from the plural documents information storing part; and (4) a document matching degree operating part for calculating the document matching degree from calculation results of the TF term operating part and the IDF term operating part, (2′) wherein the TF term operating part calculates an expectation value of a number of appearances of the search term t in the target document d in the case of including the target document d in an appropriate document set σ(t) for the search term t, by approximating the document set σ(t) by an appearing document set κ(t) which is all documents in which the search term t appears, and reflects, in the TF term, a difference of the expectation value with an actual number of appearances of the search term t in the target document d.

According to a second aspect of the present invention, to solve the aforementioned problems, there is provided a document matching degree operating system for obtaining a document matching degree as an index value indicating a matching degree of a target document with one or more search terms from information on document set to which the one or more search terms are input and includes a plurality of documents including the target document to be a search target, the document matching degree operating system comprising: (1) a plural documents information storing part for storing the information on document set; (2) a TF term operating part for calculating a TF term reflecting a frequency of the input search term in the target document by retrieving a specific information from the plural documents information storing part; (3) an IDF term operating part for calculating an IDF term reflecting an importance of the input search term in the target document by retrieving a specific information from the plural documents information storing part; and (4) a document matching degree operating part for calculating the document matching degree from calculation results of the TF term operating part and the IDF term operating part, (3′) wherein the IDF term operating part sets an average number of appearances of the search term t per document in the document in which the search term t appears as a repeatability of the search term in a document, and obtains the IDF term by the repeatability.

According to a third aspect of the present invention, to solve the aforementioned problems, there is provided a document matching degree operating method for obtaining a document matching degree as an index value indicating a matching degree of a target document with one or more search terms from information on document set to which the one or more search terms are input and includes a plurality of documents including the target document to be a search target, the document matching degree operating method comprising: (1) a TF term operating step for calculating a TF term reflecting a frequency of the input search term in the target document by retrieving specific information from a plural documents information storing part for storing information on document set; (2) an IDF term operating step for calculating an IDF term reflecting an importance of the input search term in the target document by retrieving a specific information from the plural documents information storing part; and (3) a document matching degree operating step for calculating the document matching degree from calculation results of the TF term operating step and the IDF term operating step, (1′) wherein the TF term operating step calculates an expectation value of a number of appearances of the search term t in the target document d in the case of including the target document d in an appropriate document set σ(t) for the search term t, by approximating the document set σ(t) by an appearing document set κ(t) which is all documents in which the search term t appears, and reflects, in the TF term, a difference of the expectation value with an actual number of appearances of the search term t in the target document d.

According to a fourth aspect of the present invention, to solve the aforementioned problems, there is provided a document matching degree operating method for obtaining a document matching degree as an index value indicating a matching degree of a target document with one or more search terms from information on document set to which the one or more search terms are input and includes a plurality of documents including the target document to be a search target, the document matching degree operating method comprising: (1) a TF term operating step for calculating a TF term reflecting a frequency of the input search term in the target document by retrieving specific information from a plural documents information storing part for storing information on document set; (2) an IDF term operating step for calculating an IDF term reflecting an importance of the input search term in the target document by retrieving a specific information from the plural documents information storing part; and (3) a document matching degree operating step for calculating the document matching degree from calculation results of the TF term operating step and the IDF term operating step, (2′) wherein the IDF term operating step sets an average number of appearances of the search term t per document in the document in which the search term t appears as a repeatability of the search term in a document, and obtains the IDF term by the repeatability.

A document matching degree operating program according to a fifth aspect of the present invention describes each step of the document matching degree operating method and the stored data in the plural documents information storing part in the third and fourth aspects of the present invention, in a code executable by a computer.

According to the present invention, there can be provided a document matching degree operating system, a document matching degree operating method and a document matching degree operating program which are capable of properly evaluating matching degree of document with search term irrespective of document type.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments.

FIG. 1 is a block diagram showing a functional system configuration of a document matching degree operating system in an embodiment.

FIG. 2A is an explanatory diagram showing an example of data configuration stored in an index storing part in the embodiment.

FIG. 2B is an explanatory diagram showing an example of data configuration stored in an index storing part in the embodiment.

FIG. 3 is a flowchart showing a characteristic operation of the document matching degree operating system in the embodiment.

### DETAILED DESCRIPTION OF THE PREFERRED EMBODIMENTS

Hereinafter, the preferred embodiment of the present invention will be described in reference to the accompanying drawings. Same reference numerals are attached to components having same functions in following description and the accompanying drawings, and a description thereof is omitted.

(A) Embodiment

Hereinafter, there will be described an embodiment to which a document matching degree operating system, a document matching degree operating method and a document matching degree operating program are applied in reference to drawings.

The document matching degree operating system in this embodiment is configured by searching a document appropriate for given one or more search terms from a document group and calculating a score (or evaluated value, document matching degree) of each document searched.

(A-1) Functional System Configuration of Embodiment

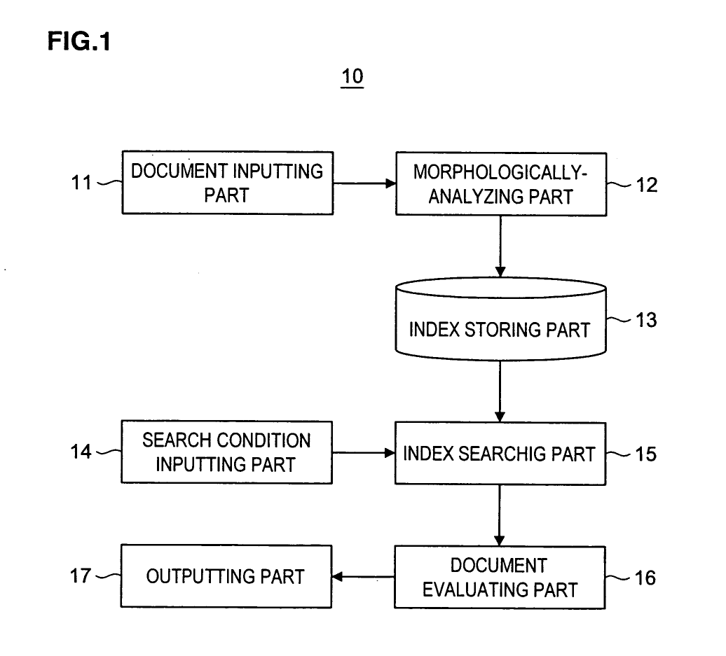

The document matching degree operating system in this embodiment is established by installing a document search program on an information processor such as a personal computer and has a configuration shown in FIG. 1 in terms of function. Note that the document matching degree operating system in this embodiment may be established as a specialized machine and each operation part may be realized by one or more ASIC and the like. Also, document matching degree operating system may be installed from a storage medium, installed by downloading from other devices or installed by input using keyboard and so on.

In FIG. 1, a document matching degree operating system 10 in this embodiment includes: a document inputting part 11; a morphologically-analyzing part 12; an index storing part 13; a search condition inputting part 14; an index searching part 15; a document evaluating part 16; and an outputting part 17.

The document inputting part 11 inputs data on each document (electronic document) to be a search target in the system 10. For example, data on each document may be input through a search function of Web page or content, or, for example, data on each document may be input by accessing a storage medium with a plurality of electronic documents stored. The way of inputting may be optional.

The morphologically-analyzing part 12 extracts a term (N-gram is also applicable) to be a keyword (index) from each document input and correlates the keyword with the document in an organized form to store in the index storing part 13.

The index storing part 13 functions as a plural documents information storing part, which corresponds to a mass-storage system (for example, a hard disk) incorporated in a personal computer and so on and to an external mass-storage system in terms of hardware, and stores the correlation between the keyword and the document.

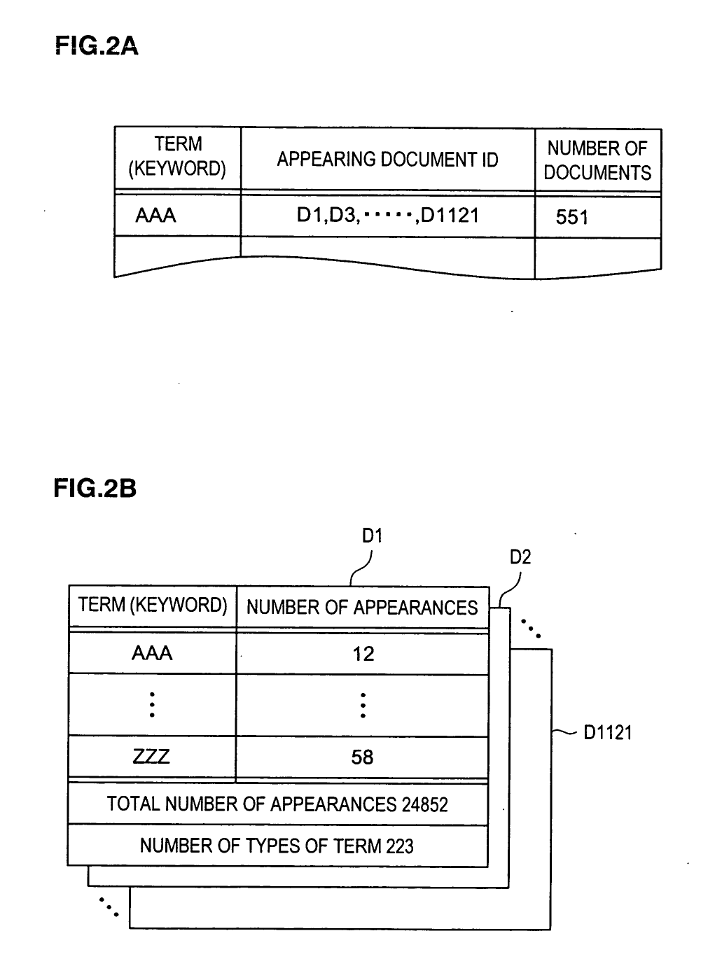

FIG. 2A and FIG. 2B are explanatory diagrams showing an example of data configuration stored in the index storing part 13. In this embodiment, the data stored in the index storing part 13 is organized from the following viewpoints: first, as shown in FIG. 2A, the data is organized by focusing on each term (keyword) and the data is configured by the term, the ID of document in which the term appears (the ID may be already assigned in inputting) and the number of documents in which the term appears; secondly, as shown in FIG. 2B, the data is organized by focusing on each document and the data is configured by the term included in the document, the number of appearances thereof and information on the document length. In the example of FIG. 2B, summation of the number of appearances of the keyword in the document is applied as the information on the document length. Total character count is also applicable as information on the document length.

Here, all documents with data stored in the index storing part 13 may be set as the document set to be a search target and information on document specifying a document to be a search target may be input in inputting a search condition to be described later. In FIGS. 2A and 2B, for example, the following configurations are applicable. The category name of document, which is not described, is termed to each document, or when the category name is input in the search condition only the document of the category name becomes the search target. Or, input operation of document is performed certainly in searching and one or more documents input become the search target.

The search condition inputting part 14 is the part for inputting the search condition such as search term. In the search condition inputting part 14, the search condition may be input by using a keyboard or by reading data from a storage medium. The search term may be configured by inputting the search term itself or by extracting automatically a term (for example, noun) configuring the downloaded sentence by the search condition inputting part 14. The maximum number of document to be searched and the way of outputting may be included in the search condition, and information to define the document set to be a search target as described above may be included therein.

The index searching part 15 functions as a TF term operating part and an IDF term operating part, and extracts data needed by the document evaluating part 16 from the index storing part 13 to send the data to the document evaluating part 16. The index searching part 15 sends data on the document ID in which a given search term appears, the number of appearances in the document ID, summation of the number of appearances of the keyword in the document ID, the number of types of keyword, the number of appearances of the search term in all documents, the number of appearing documents and so on, to the document evaluating part 16.

The document evaluating part 16 functions as a document matching degree operating part and assigns a score (evaluated value) to each document matching the search condition. In this embodiment, the document evaluating part 16 is characterized by an evaluating function, which will be described later. The document evaluating part 16 sends information on one or more documents with high degree of matching the search condition, i.e., a search result to the outputting part 17.

The outputting part 17 is the part for outputting the search result. The outputting part 17 may be the part for displaying and outputting the search result, for printing and outputting the search result, for forwarding the search result to other devices, or for storing the search result in a storage medium. Although a specific number of results are output in descending order of evaluated value by the document evaluating part 16 generally, there is a system matching demands of obtaining results disagreeing with each other and obtaining a part unclear whether the results agree with each other or not. The way of outputting may be optional.

(A-2) Document Score Calculating Method in Embodiment

The document evaluating part 16 obtains the score of the searched document in accordance with the following formula (6), in which TF(., t) is the sum of the number of appearances TF(d, t) of the term t in all documents of a document group to be a search target and α1 and α2 are parameters having meanings described later.

$$Score ( d ) = {\sum }_{1} ( \frac{TF ( d , t )}{\frac{TF ( . , t ) \cdot length ( d )}{DF ( t ) \cdot Δ} + TF ( d , t )} \cdot log ( \frac{N}{DF ( t )} {( \frac{TF ( . , t )}{{α}_{1} DF ( t )} )}^{{α}_{2}} ) ) \qquad Formula ( 6 )$$

To solve the aforementioned problems A-C, formula (6) is applied. Hereinafter, the way of thinking leading to applying the formula (6) will be described.

In the problems A and B, even when the document is appropriate for the search result, the number of appearances TF(d, t) of the search term hard to be repeated becomes small, in other words, the number of the search term per unit document length (TF(d, t)·Δ/length (d)) becomes small, and therefore the score becomes too low.

In the problem C, contrary to the problems A and B, the search term with little meanings statistically having small number of appearances TF(d, t) constantly is emphasized similarly to other search terms appearing in almost the same number DF(t) of documents. And the score is not lowered.

In other words, the problems A and B display a tendency contrary to that in the problem C, and the problems A and B and the problem C have effects counteracting each other.

In the problems A and B, in this embodiment, the TF term of a term hard to be repeated is set so as not to be too small while in the problem C a term likely to be repeated in the IDF term is to gain importance. Thereby the degree of effects can be controlled by parameter to keep a balance. And thereby an upgrade is realized in a search target including many terms hard to be repeated, and even when the repeatability of term is changed by the document group to be a search target, there is provided a search method with unchangeable tendency of score.

First, there is considered applying a TF term shown in formula (7) instead of the conventional formula (2) with regard to the TF term for calculating the score related to the search term t in a specific document d, in order for the TF term hard to be repeated not to be small. Note that the TF term shown in the formula (7) can be modified to be shown by formula (9) by introducing h(t) shown in formula (8).

$$\begin{matrix}TF term = \frac{TF ( d , t )}{{k}_{3} \frac{TF ( . , t )}{DF ( t )} \cdot \frac{length ( d )}{Δ} + TF ( d , t )} & Formula ( 7 ) \\ h ( t ) = \frac{TF ( . , t )}{DF ( t )} \cdot \frac{length ( d )}{Δ} & Formula ( 8 ) \\ TF term = \frac{\frac{TF ( d , t )}{h ( t )}}{{k}_{3} + \frac{TF ( d , t )}{h ( t )}} & Formula ( 9 )\end{matrix}$$

In the formula (7), TF(., t) is the sum of the number of appearances TF(d, t) of the term t in all documents in the document group to be a search target. The smaller k3, which is a parameter for tuning, becomes, the higher the score of the document including the search term with more types is likely to be (AND-search effect) while the larger k3 becomes, the higher the score of the document including many input search terms with any types (OR-search effect). In the case of the above formula (6), 1 is applied as k3.

And h(t) is an approximate value of the value in which the search term t is expected to appear in the document d when the document d is appropriate for the search term t. It is possible to judge as follows: when h(t) is larger than the expected value the document is appropriate for the search term well, while when h(t) is smaller the document is not appropriate for the search term very well. Introducing the value in which the search term t is expected to appear in the document d, the score is not influenced even by different repeatability (likelihood of appearance) in the document d according to the search term t, which can, in other words, cope with the above problems A and B to solve the problems.

There will be described that h(t) is an expectation value of the appearance of the search term t in the document d.

First, there is calculated the frequency of appearance of the search term t per unit document length in the document group σ(t) appropriate for the term. An average document length of the document group σ(t) is set as Λ(σ(t)), which is the result of division of a total document length (summation of document length) of the document group σ(t) by a total document number DF(σ(t)) of the document group σ(t). In other words, the total document length of the document group a (t) is represented by DF(σ(t))·Λ(σ(t)). Setting the total number of appearances of the search term t in the document group σ(t) as TF(σ(t), t), the number of appearances of the search term t per unit document length is represented by TF(σ(t),t)/DF(σ(t))·Λ(σ(t)). When the value shown in formula (10) which is the result of multiplication of TF(σ(t), t)/DF(σ(t))·Λ(σ(t)) by length (d) (length of the document d) indicates that the document d is appropriate for the search term t, the value becomes the value in which the search term t is expected to appear in the document d.
TF(σ(t),t)·length(d)/DF(σ(t))·Λ(σ(t)) Formula (10)

However in actuality, it is impossible to know the document group a (t) appropriate for the search term t in advance, since an object of the search system (the document matching degree operating system) in the present invention is to obtain the document group σ(t) from the search term t and it makes no sense to provide a system assuming knowing in advance.

Therefore, since σ(t) in the formula (10) cannot be obtained in advance, σ(t) will be approximated by the appearing document set κ(t), the document in which the search term t appears. With this approximation, there arises an error between σ(t) and κ(t), by the document in which the search term t appears but which is inappropriate in fact or the document in which the search term t does not appear but which is appropriate in fact. However, this error using the above approximation does not matter in actuality.

Approximating document group σ(t) by the appearing document set κ(t), there is obtained TF(σ(t), t)≈TF(κ(t), t), in which TF(κ(t), t) is the sum of the number of the search term t in all documents in which the search term t appears. Since the search term t is not included in the document other than κ(t), the number of the search term t is 0 in the document other than κ(t). In other words, the value is not changed by adding the number of the search term t in the document other than κ(t) to TF(κ(t), t). Consequently, TF(σ(t), t) equals to the sum of the number TF(κ(t), t) of the search terms t in κ(t) and the number of the search terms t in the document other than κ(t). In other words, the sum is the number TF(., t) of the search terms t in all documents.

DF(σ(t))(≈DF(κ(t), t)) is the number of documents in the appearing document set κ(t). However, since the appearing document set κ(t) is the document set in which the search term t appears, the appearing document set κ(t) equals to the number DF(t) of the document.

Λ(σ(t))(≈Λ(κ(t))) is an average document length of the document in the appearing document set κ(t).

By approximating σ(t) by the appearing document set κ(t), the formula (10) described above will be approximated by formula (11), which is configured only by the value prepared by calculating each parameter every term or every document before searching process in advance and which is formed to be applicable to searching process.
TF(.,t)·length(d)/DF(t)·Λ(k(t)) Formula (11)

With regard to Λ(κ(t)) in the formula (11), however, it is necessary to sum all lengths of the documents in which the search term appears and divide the sum by the number of documents for all search terms, differently from TF(., t) and DF(t) in which only counting the number is sufficient. Therefore, calculation amount increases and there is the fear of causing a problem in performance.

Here, the appearing document set κ(t) is a part of all documents and can be assumed to have similar tendencies to each other. In other words, the value of the appearing document set κ(t) and the value of all documents are almost the same in the averaged document length even when individual lengths of documents are different from each other, so it can be assumed that it is possible to approximate to deal with the values equally. Setting Λ(κ(t))≈Δ(Δ is an average document length in all documents), h(t) shown in the above formula (8) becomes applicable instead of the formula (11).

Applying the TF term (formula (7)) according to the above concept, it becomes possible to solve the problems A and B in which the score by the TF term is changed by repeatability of the term t in the document.

As described above, while the problems A and B stand out the problem C does not, and while the problems A and B do not stand out the problem C does. When the problems A and B on the TF term have been solved, the problem C hid behind the problems A and B stands out. For this reason, it is preferable to correct not only the TF term but also the IDF term from the formula (3). In this embodiment, the IDF term is solved as follows.

Formula (12) shows the IDF term in this embodiment, which is corrected from the conventional IDF term by correction term shown in formula (13). The IDF term shown in the formula (12) is incorporated in the score in this embodiment as applied to the formula (6) described above.

$$\begin{matrix}IDF term = log ( \frac{N}{DF ( t )} {( \frac{TF ( . , t )}{{α}_{1} DF ( t )} )}^{{α}_{2}} ) & Formula ( 12 ) \\ {( \frac{TF ( . , t )}{{α}_{1} DF ( t )} )}^{{α}_{2}} & Formula ( 13 )\end{matrix}$$

Hereinafter, meaning of this correction will be described.

TF(., t)/DF(t) in the formula (12) is the result of division of total number of the appearances of the search term t in all documents, in other words, the TF(., t) to be the total number of the appearances of the search term t in the documents in which the search term t appears by the number DF(t) of the document in which the search term t appears. In brief, TF(., t)/DF(t) is an average number of appearances of the search term t in a plurality of documents in which the search term t appears. When the value TF(., t)/DF(t) is too small, for example, 1 in an extreme case, TF(., t) can take only 0 and 1, and consequently, there are only two scores in the formulae (7) and (8). Further, the score will be decided almost only by the document length of the document d, which makes it difficult to obtain a statistically-stable score. For this reason, the IDF term is configured as the formula (12) so that the term t can gain importance as TF(., t)/DF(t) becomes large.

Here, α1 is a parameter for tuning to be inserted so as to set the correction term at almost 1 (in other words, not to perform correction) when TF(., t)/DF(t) is a standard value. Also, α2 is a parameter for determining the strength of correction with the increase or decrease of TF(., t)/DF(t). α1 and α2 are determined experientially, for example, 2.0 and 0.7 can be applied to α1 and α2, respectively. In the case where the group is constituted only by Japanese document or only by English document, parameters α1 and α2 may take values different from each other or parameters α1 and α2 may take values to be different every category to which the document set belongs.

Setting the above formula (6) (k3 may take the value other than 1) in which the TF and IDF terms have been improved as above as the score of the document d makes it possible to control the balance between the problems A and B and the problem C which have display a tendency contrary to each other.

(A-3) Characteristic Process in Embodiment

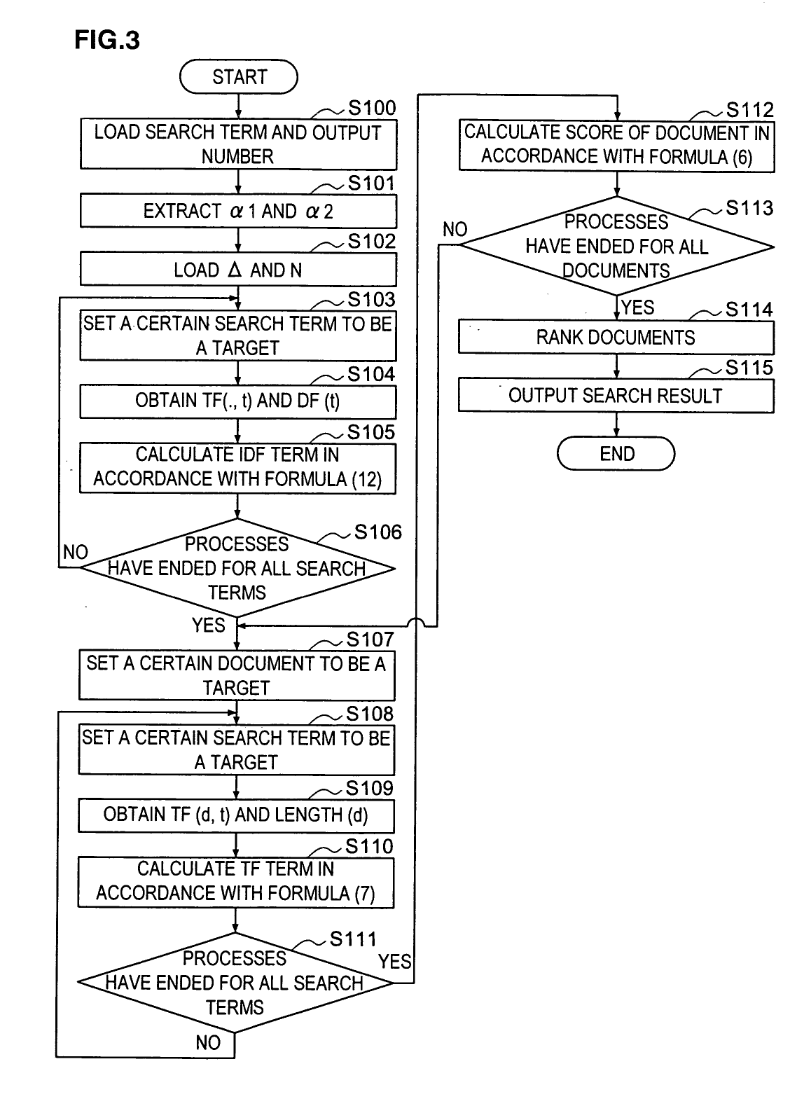

It suffices if the document evaluating part 16 can calculate the value shown in the formula (6) as the score of the document d. FIG. 3 is a flowchart showing an example of process in the index searching part 15 and the document evaluating part 16.

When one or more search terms (t1, t2, . . . ) and a number n of document ID to be included in the search result are given (S100), the internally-stored parameters α1 and α2 (and, in the case of k3 taking other than 1, k3) are extracted (S101). Then there are loaded the value Δ(average document length of all documents) which does not relate to the document d and the search term t, and N (total document number) from the index storing part 13 (S102). When Δ and N themselves are not stored in the index storing part 13, Δ and N may be obtained by counting the number in extracting. In addition, the extracted A and N are stored in the document evaluating part 16 till the end of the process in FIG. 3.

Next, setting a certain search term t (=t1) to be a process target (S103), and obtaining the total number TF(., t) of the appearances of the search term t in all documents and the number DF(t) of the document in which the search term t appears (S104), the IDF term for the search term is calculated in accordance with the formula (12) to store internally (S105). Also in this case, when TF(., t) and DF(t) themselves are not stored in the index storing part 13, TF(., t) and DF(t) may be obtained by counting the number in extracting. In addition, the extracted TF(., t) and DF(t) are stored in the document evaluating part 16 till the end of the process in FIG. 3.

Confirming whether the processes in the steps S104 and S105 have ended for all search terms (t1, t2, . . . ) (S106), there goes back to the step S103 in the case of unended.

When the processes in the steps S104 and S105 have ended for all search terms and the IDF term is obtained, a certain document d (for example, D1) becomes a process target (S107) and a certain search term t (=t1) becomes a process target (S108). Then the number TF(d, t) of appearances of the target search term t in the target document d and the length of the target document d (length (d)) are obtained from the storage information in the index storing part 13 (S109), to store internally by calculating the TF term for the target search term t in the target document d in accordance with the formula (7) (S110). Also in this case, when TF(d, t) and length (d) themselves are not stored in the in the index storing part 13, TF(d, t) and length (d) may be obtained by counting the number in extracting. In addition, the extracted TF(d, t) and length (d) are stored in the document evaluating part 16 till the end of the process in FIG. 3.

Confirming whether the processes in the steps S109 and S110 have ended for all search terms (t1, t2, . . . ) (S11), there goes back to the step S108 in the case of unended.

When the processes in the steps S109 and S110 have ended for all search terms and the TF term for all search terms (t1, t2, . . . ) is obtained for the target document d, the score of the target document d is calculated in accordance with the formula (6) (S112).

And then confirming whether the score has been calculated for all documents (S113), there goes back to the step S107 in the case where the score has not been obtained.

When the score has been obtained for all documents, ranking the documents (S114), and obtaining the document ID of the number n specified from the upper rank to send the document ID as the search result to the outputting part 17 (S115), a series of processes shown in FIG. 3 ends.

(A-4) Effect of Embodiment

According to the embodiment as described above, the following effects can be obtained.

In the method conventionally taken and using the number of the search terms t per unit document length, the score is calculated despite of low score caused by either case: (a) the sentence is inappropriate for the search term t; or (b) the search term t is hard to be repeated originally.

However in the embodiment as described above, with the approximation “the document appropriate for the search term t as the search result is all documents including the search term t and the document other than the documents is inappropriate for the search term t”, there is realized a calculation of evaluated value (score) of the document by comparing “the expectation value of the number of appearances of the search term t in the document appropriate for the search term t” with the actual number of appearances of the search term t in the document. Since the expectation value compared with the number of appearances of term is small in the search term hard to be repeated, the score does not become small erroneously in the case of (b). Thereby even when there are the term likely to be repeated and the term unlikely to be repeated, the score can be calculated correctly to improve accuracy, in other words, to solve the conventional problem A.

When the document set to be a search target is constituted by the document such as article and patent document in which the term is likely to be repeated, the expectation value of the search term is large on the whole while in the case of the document other than the above document the expectation value of the search term is small, so the expectation value compared with the number of appearances of the search term adapts thereto. Thereby it becomes possible to compare correctly the scores with each other in the search results in different document sets which are different in repeatability of term, in other words, to solve the conventional problem B.

With regard to the fact that the score calculated is more stable statistically as the evaluated value in the case of large number of appearances of search term in the document, there can be solved by considering the number of appearances of the search term per document for the importance of search term as formula (12). In addition, the parameter Δ2 can control the degree of influence brought thereby. Thereby, it becomes possible for the problem C to adjust intentionally what has been canceled by the problems A and B and to be prevented from standing out by solving the problems A and B.

(B) Another Embodiment

Although the preferred embodiment of the present invention has been described referring to the accompanying drawings, the present invention is not restricted to such examples. It is evident to those skilled in the art that the present invention may be modified or changed within a technical philosophy thereof and it is understood that naturally these belong to the technical philosophy of the present invention.

Although the approximation formula of the formula (8) is applied to the part where the formula (11) should be applied in consideration of the amount of calculation in the above embodiment, the formula (11) may be applied as it is to obtain the score of document.

Although the IDF term is calculated collectively and the score is calculated by obtaining the TF term every document in the above embodiment, it is a matter of course that the order of calculating TF term, IDF term and score is not limited thereto.

Although, in addition, the technical idea of the present invention is introduced to the formula (1) for calculating score in the form of multiplication of TF term and IDF term in the above embodiment, the formula for calculating score is not limited to the formula (1). In other words, it suffices if it is possible to reflect on the TF term the difference between “the expectation value of the number of appearances of the search term t in the document appropriate for the search term t” and the actual number of appearances of the search term t in the document with the approximation “the document appropriate for the search term t as the search result is all documents including the search term t and the document other than the documents is inappropriate for the search term t”. Also, it suffices if it is possible to introduce the correction term into the IDF term so as to prevent the problem of IDF term from being bigger as such a modification of TF term.

Further, although the present invention is applied to a document matching degree operating system in the above embodiment, the application of the present invention is not limited thereto. For example, the present invention is applicable to the case of obtaining the score of a certain document specified, as well as the case classifying a document set by using a search term.

1. A document matching degree operating system for obtaining a document matching degree as an index value indicating a matching degree of a target document with one or more search terms from information on document set to which the one or more search terms are input and includes a plurality of documents including the target document to be a search target, the document matching degree operating system comprising:
a plural documents information storing part for storing the information on document set;
a TF term operating part for calculating a TF term reflecting a frequency of the input search term in the target document by retrieving a specific information from the plural documents information storing part;
an IDF term operating part for calculating an IDF term reflecting an importance of the input search term in the target document by retrieving a specific information from the plural documents information storing part; and
a document matching degree operating part for calculating the document matching degree from calculation results of the TF term operating part and the IDF term operating part,
wherein the TF term operating part calculates an expectation value of a number of appearances of the search term in the target document in the case of including the target document in an appropriate document set for the search term, by approximating the document set by an appearing document set which is all documents in which the search term appears, and reflects, in the TF term, a difference of the expectation value with an actual number of appearances of the search term in the target document.

2. A document matching degree operating system according to claim 1 wherein the TF term operating part calculates the expectation value by approximating an average document length of the appearing document set which is all documents in which the search term appears by an average document length of all document sets.

3. A document matching degree operating system according to claim 2 wherein the IDF term operating part sets an average number of appearances of the search term per document in the document in which the search term appears as a repeatability of the search term in a document, and obtains the IDF term by the repeatability.

4. A document matching degree operating system according to claim 1 wherein the IDF term operating part sets an average number of appearances of the search term per document in the document in which the search term appears as a repeatability of the search term in a document, and obtains the IDF term by the repeatability.

5. A document matching degree operating system for obtaining a document matching degree as an index value indicating a matching degree of a target document with one or more search terms from information on document set to which the one or more search terms are input and includes a plurality of documents including the target document to be a search target, the document matching degree operating system comprising:
a plural documents information storing part for storing the information on document set;
a TF term operating part for calculating a TF term reflecting a frequency of the input search term in the target document by retrieving a specific information from the plural documents information storing part;
an IDF term operating part for calculating an IDF term reflecting an importance of the input search term in the target document by retrieving a specific information from the plural documents information storing part; and
a document matching degree operating part for calculating the document matching degree from calculation results of the TF term operating part and the IDF term operating part,
wherein the IDF term operating part sets an average number of appearances of the search term per document in the document in which the search term appears as a repeatability of the search term in a document, and obtains the IDF term by the repeatability.

6. A document matching degree operating method for obtaining a document matching degree as an index value indicating a matching degree of a target document with one or more search terms from information on document set to which the one or more search terms are input and includes a plurality of documents including the target document to be a search target, the document matching degree operating method comprising:
a TF term operating step for calculating a TF term reflecting a frequency of the input search term in the target document by retrieving specific information from a plural documents information storing part for storing information on document set;
an IDF term operating step for calculating an IDF term reflecting an importance of the input search term in the target document by retrieving a specific information from the plural documents information storing part; and
a document matching degree operating step for calculating the document matching degree from calculation results of the TF term operating step and the IDF term operating step.

7. A document matching degree operating method according to claim 6 wherein the TF term operating step calculates an expectation value of a number of appearances of the search term in the target document in the case of including the target document in an appropriate document set for the search term, by approximating the document set by an appearing document set which is all documents in which the search term appears, and reflects, in the TF term, a difference of the expectation value with an actual number of appearances of the search term in the target document.

8. A document matching degree operating method according to claim 7 wherein the TF term operating step calculates the expectation value by approximating an average document length of the appearing document set which is all documents in which the search term appears by an average document length of all document sets.

9. A document matching degree operating method according to claim 6 wherein the IDF term operating step sets an average number of appearances of the search term per document in the document in which the search term appears as a repeatability of the search term in a document, and obtains the IDF term by the repeatability.
